(19) United States
(12) Patent Application Publication
(10) Pub. No.: US 2009/0143549 A1
(43) Pub. Date: Jun. 4, 2009

(54) Catalyst Components for the Polymerization of Olefins

(75) Inventor: Diego Brita, Ferrara (IT)

Correspondence Address: Basell USA Inc., Delaware Corporate Center II, 2 Righter Parkway, Suite #300, Wilmington, DE, 19803, US

(73) Assignee: Basell Poliolefine Italia s.r.l., Milan (IT)

(21) Appl. No.: 11/886,112

(22) PCT Filed: Feb. 21, 2006
(86) PCT No.: PCT/EP2006/060128

§ 371 Date: Sep. 11, 2007

Related U.S. Application Data
(60) Provisional application No. 60/662,011, filed on Mar. 15, 2005.

(30) Foreign Application Priority Data
Mar. 11, 2005 (EP) 05101894.3

(51) Int. Cl. C08F 2/00; C08F 4/54

(52) U.S. Cl. 526/124.9; 502/125

(57) ABSTRACT

The present invention relates to catalysts component for the polymerization of ethylene and its mixtures with olefins CH₂═CHR, wherein R is an alkyl, cycloalkyl or aryl radical having 1-12 carbon atoms, comprising Ti, Mg, halogen, and 1,2-dimethoxyethane as internal electron donor compound. The catalyst of the invention is suitably used in (co)polymerization processes of ethylene to prepare (co)polymers having narrow Molecular Weight Distribution (MWD) and high bulk density.

This application is the U.S. national phase of International Application PCT/EP2006/060128, filed Feb. 21, 2006, claiming priority to European Patent Application 05101894.3 filed Mar. 11, 2005, and the benefit under 35 U.S.C. 119(e) of U.S. Provisional Application No. 60/662,011, filed Mar. 15, 2005; the disclosures of International Application PCT/EP2006/060128, European Patent Application 05101894.3 and U.S. Provisional Application No. 60/662,011, each as filed, are incorporated herein by reference.

The present invention relates to catalysts component for the polymerization of ethylene and its mixtures with olefins CH₂═CHR, wherein R is an alkyl, cycloalkyl or aryl radical having 1-12 carbon atoms, comprising Ti, Mg, halogen, and a particular electron donor compound. The catalyst of the invention is suitably used in (co)polymerization processes of ethylene to prepare (co)polymers having narrow Molecular Weight Distribution (MWD) and high bulk density. The MWD is an important characteristic of ethylene polymers in that it affects both the rheological behavior, and therefore the processability, and the final mechanical properties. In particular, polymers with narrow MWD are suitable for films and injection molding in that deformation and shrinkage problems in the manufactured article are minimized. The width of the molecular weight distribution for the ethylene polymers is generally expressed as melt flow ratio F/E, which is the ratio between the melt index measured by a load of 21.6 Kg (melt index F) and that measured with a load of 2.16 Kg (melt index E). The measurements of melt index are carried out according to ASTM D-1238 and at 190° C. Catalysts for preparing ethylene (co)polymers having narrow MWD are described in the European patent application EP-A-373999. The catalyst comprises a solid catalyst component consisting of a titanium compound supported on magnesium chloride, an alkyl-Al compound and an electron donor compound (external donor) selected from monoethers of the formula R′OR″. Good results in terms of narrow MWD are only obtained when the solid component also contains an internal electron donor compound (diisobutylphthalate). The catalyst activity is rather low and, in addition, the cited document does not disclose or teach anything about the polymer bulk density provided by the catalyst. This latter characteristic is very important in the operation of the plants because it assures smooth polymer flow and high productivity. Hence, it would be highly desirable to have a catalyst capable to produce polymers with narrow molecular weight distribution, high bulk density in high yields.

WO03/106511 describes catalyst components containing diethers as internal donors which are suitable for the preparation of LLDPE polymers with improved comonomer randomization. These solid catalyst components comprise Mg, Ti, Cl, OR groups, where R is a C1-C10 alkyl group optionally containing heteroatoms, and an ether having two or more ether groups, and are characterized by the fact that the Mg/Ti weight ratio is lower than 3, the Cl/Ti weight ratio is from 1.5 to 6, the OR/Ti weight ratio is from 0.5 to 3.5 and at least 50% of the titanium atoms is in a valence state lower than 4. In said document is reported preparation of catalysts having a very high amount (21.8%) of 1,2-dimethoxyethane as internal donor. In the ethylene copolymerization said catalysts seem able to narrow the MWD. However, their activity seems to decrease with respect to the reference catalyst not containing the donor unless high amounts of donors and/or specific polymerization conditions are used.

EP 361494 discloses the use of several ethers and diethers as internal donor in the preparation of catalysts for the stereospecific polymerization of propylene. In comparison example 3, 1,2-dimethoxyethane is used as internal donor which remains fixed on the catalyst in an amount of 4% wt. The catalyst displays poor properties in term of both activity and stereospecificity.

The applicant has now found catalyst components capable of satisfying the above-mentioned needs that comprise Mg, Ti, halogen as essential elements and containing 1,2-dimethoxyethane in an amount of less than 4% wt with respect to the total weight of the catalyst component.

Based on the teaching of the prior art it has been very surprising to find that such low amounts of 1,2-dimethoxyethane are able to show so improved properties. Preferably, 1,2-dimethoxyethane is present in an amount ranging from 1 to 3.8% by weight and more preferably from 1.4 to 3.5%.

Particularly preferred are the solid catalyst components in which the Ti atoms derive from a titanium compound which contains at least one Ti-halogen bond and the Mg atoms derive from magnesium chloride. In a still more preferred aspect both the titanium compound and the 1,2-dimethoxyethane are supported on magnesium dichloride. Preferably, in the catalyst of the present invention at least 70% of the titanium atoms and more preferably at least 90% of them, is in the +4 valence state.

In a particular embodiment, the magnesium dichloride is in active form. The active form of magnesium dichloride present in the catalyst components of the invention is recognizable by the fact that in the X-ray spectrum of the catalyst component the major intensity reflection which appears in the spectrum of the non-activated magnesium dichloride (having usually surface area smaller than 3 m²/g) is no longer present, but in its place there is a halo with the position of the maximum intensity shifted with respect to the position of the major intensity reflection, or by the fact that the major intensity reflection presents a half-peak breadth at least 30% greater that the one of the corresponding reflection of the non-activated Mg dichloride. The most active forms are those in which the halo appears in the X-ray spectrum of the solid catalyst component.

In the case of the most active forms of magnesium dichloride, the halo appears in place of the reflection which in the spectrum of the non-activated magnesium chloride is situated at the interplanar distance of 2.56 Å.

Preferred titanium compounds are the halides or the compounds of formula TiXₙ(OR¹)₄₋ₙ, where 1≦n≦3, X is halogen, preferably chlorine, and R¹ is C₁-C₁₀ hydrocarbon group. Especially preferred titanium compounds are titanium tetrachloride and the compounds of formula TiCl₃OR¹ where R¹ has the meaning given above and in particular selected from methyl, n-butyl or isopropyl.

The preparation of the solid catalyst components can be carried out using various methods. For example, the magnesium chloride (preferably used in a form containing less than 1% of water), the titanium compound and the 1,2-dimethoxyethane can be milled together under conditions that cause the activation of the magnesium dichloride; the milled product is then caused to react one or more times with TiCl₄ in excess, optionally in the presence of an electron-donor, at a temperature ranging from 80 to 135° C., and then repeatedly washed with a hydrocarbon liquid at room temperature (such as hexane) until no chlorine ions can be detected in the wash liquid.

A preferred method comprises the reaction between magnesium alcoholates or chloroalcoholates (in particular chloroalcoholates prepared according to U.S. Pat. No. 4,220,554) and an excess of TiCl containing the 1,2-dimethoxyethane.

In this case also the operation takes place at a temperature between 80° and 135° C. The reaction with TiCl₄, in the optional presence of 1,2-dimethoxyethane, may be repeated and the solid is then washed with hexane to eliminate the non-reacted TiCl₄.

In a further preferred method, a MgCl₂.nROH adduct (particularly in the form of spheroidal particles) where n is generally from 1 to 6, and ROH is an alcohol, preferably ethanol, is caused to react with an excess of liquid TiCl₄ containing 1,2-dimethoxyethane and optionally one of the above mentioned hydrocarbon solvents. The reaction temperature initially is from 0° to 25° C., and is then increased to 80-135° C. Then, the solid may be reacted once more with TiCl₄, in the optional presence of 1,2-dimethoxyethane, separated and washed with a liquid hydrocarbon until no chlorine ions can be detected in the wash liquid.

The MgCl₂.nROH adduct can be prepared in spherical form from melted adducts, by emulsifying the adducts in a liquid hydrocarbon and thereafter causing them to solidify by fast quenching. Representative methods for the preparation of these spherical adducts are reported for example in U.S. Pat. No. 4,469,648, U.S. Pat. No. 4,399,054, and WO98/44009. Another useable method for the spherulization is the spray cooling described for example in U.S. Pat. Nos. 5,100,849 and 4,829,034.

The catalyst components obtained with this method can have size ranging from 1 to 150 μm to preferably from 5 to 100 μm.

In a preferred aspect of the present invention, before being reacted with the titanium compound, the spherulized adducts are subjected to thermal dealcoholation at a temperature ranging from 50 and 150° C. until the alcohol content is reduced to values lower than 2 and preferably ranging from 1.5 and 0.3 mols per mol of magnesium chloride.

Optionally, said dealcoholated adducts can be finally treated with chemical reagents capable of reacting with the OH groups of the alcohol and of further dealcoholating the adduct until the content is reduced to values which are generally lower than 0.5 mols.

The MgCl₂/1,2-dimethoxyethane molar ratio used in the reactions indicated above preferably ranges from 7:1 to 40:1, preferably from 8:1 to 35:1.

The solid catalyst components according to the present invention are converted into catalysts for the polymerization of olefins by reacting them with organoaluminum compounds according to known methods.

In particular, it is an object of the present invention a catalyst for the polymerization of olefins CH₂═CHR, in which R is hydrogen or a hydrocarbyl radical with 1-12 carbon atoms, comprising the product of the reaction between:

(a) a solid catalyst component as described above,
(b) an alkylaluminum compound and, optionally,
(c) an external electron donor compound.

The alkyl-Al compound can be preferably selected from the trialkyl aluminum compounds such as for example trimethylaluminum (TMA), triethylaluminum (TEAL), triisobutylaluminum (TIBA)), tri-n-butylaluminum, tri-n-hexylaluminum, tri-n-octylaluminum. Also alkylaluminum halides and in particular alkylaluminum chlorides such as diethylaluminum chloride (DEAC), diisobutylalumunum chloride, Al-sesquichloride and dimethylaluminum chloride (DMAC) can be used. It is also possible to use, and in certain cases preferred, mixtures of trialkylaluminum's with alkylaluminum halides. Among them mixtures between TEAL and DEAC are particularly preferred. The use of TIBA, alone or in mixture is also preferred. Particularly preferred is also the use of TMA.

The external electron donor compound can be selected from the group consisting of ethers, esters, amines, ketones, nitrites, silanes and mixtures of the above. In particular, it can advantageously be selected from the C2-C20 aliphatic ethers and in particulars cyclic ethers preferably having 3-5 carbon atoms cyclic ethers such as tetrahydrofurane, dioxane.

In addition, the electron donor compound can also be advantageously selected from silicon compounds of formula Rₐ⁵R_{b}⁶Si(OR⁷)_{c}, where a and b are integer from 0 to 2, c is an integer from 1 to 3 and the sum (a+b+c) is 4; R⁵, R⁶, and R⁷, are alkyl, cycloalkyl or aryl radicals with 1-18 carbon atoms optionally containing heteroatoms. Particularly preferred are the silicon compounds in which a is 0, c is 3, R⁶ is a branched alkyl or cycloalkyl group, optionally containing heteroatoms, and R⁷ is methyl. Examples of such preferred silicon compounds are cyclohexyltrimethoxysilane, t-butyltrimethoxysilane and thexyltrimethoxysilane.

The above mentioned components (a)-(c) can be fed separately into the reactor where, under the polymerization conditions can exploit their activity. It constitutes however a particular advantageous embodiment the pre-contact of the above components, optionally in the presence of small amounts of olefins, for a period of time ranging from 0.1 to 120 minutes preferably in the range from 1 to 60 minutes. The pre-contact can be carried out in a liquid diluent at a temperature ranging from 0 to 90° C. preferably in the range of 20 to 70° C.

The so formed catalyst system can be used directly in the main polymerization process or alternatively, it can be pre-polymerized beforehand. A pre-polymerization step is usually preferred when the main polymerization process is carried out in the gas phase. The prepolymerization can be carried out with any of the olefins CH₂═CHR, where R is H or a C1-C10 hydrocarbon group. In particular, it is especially preferred to pre-polymerize ethylene, propylene or mixtures thereof with one or more α-olefins, said mixtures containing up to 20% in moles of α-olefin, forming amounts of polymer from about 0.1 g per gram of solid component up to about 1000 g per gram of solid catalyst component. The pre-polymerization step can be carried out at temperatures from 0 to 80° C., preferably from 5 to 70° C., in the liquid or gas phase. The pre-polymerization step can be performed in-line as a part of a continuous polymerization process or separately in a batch process. The batch pre-polymerization of the catalyst of the invention with ethylene in order to produce an amount of polymer ranging from 0.5 to 20 g per gram of catalyst component is particularly preferred. The pre-polymerized catalyst component can also be subject to a further treatment with a titanium compound before being used in the main polymerization step. In this case the use of TiCl₄ is particularly preferred. The reaction with the Ti compound can be carried out by suspending the prepolymerized catalyst component in the liquid Ti compound optionally in mixture with a liquid diluent; the mixture is heated to 60-120° C. and kept at this temperature for 0.5-2 hours.

The catalysts of the invention can be used in any kind of polymerization process both in liquid and gas-phase processes. Catalysts having small particle size, (less than 40 μm) are particularly suited for slurry polymerization in an inert medium, which can be carried out continuously stirred tank reactor or in loop reactors. Catalysts having larger particle size are particularly suited for gas-phase polymerization processes which can be carried out in agitated or fluidized bed gas-phase reactors.

Examples of gas-phase processes wherein it is possible to use the catalysts of the invention are described in WO 92/21706, U.S. Pat. No. 5,733,987 and WO 93/03078. These processes comprise a pre-contact step of the catalyst components, a pre-polymerization step and a gas phase polymerization step in one or more reactors in a series of fluidized or mechanically stirred bed. In a particular embodiment, the gas-phase process can be suitably carried out according to the following steps:
(i) contacting the catalyst components (a), (b) and optionally (c) for a period of time ranging from 0.1 to 120 minutes, at a temperature ranging from 0 to 90° C.; optionally
(ii) pre-polymerizing with one or more olefins of formula CH₂═CHR, where R is H or a C1-C10 hydrocarbon group, up to forming amounts of polymer from about 0.1 up to about 1000 g per gram of solid catalyst component (a); and
(iii) polymerizing in the gas-phase ethylene, or mixtures thereof with α-olefins CH₂═CHR in which R is a hydrocarbon radical having 1-10 carbon atoms, in one or more fluidized or mechanically stirred bed reactors, in the presence of the product coming from (i) or (ii).

As already mentioned, the catalysts of the present invention are particularly suitable for preparing ethylene polymers having narrow molecular weight distribution that are characterized by a F/E ratio of lower than 35 and in many cases lower than 30. At the same time and particularly in slurry processes, a bulk density of higher than 3 can be obtained.

When the ethylene is polymerized together with a minor amount of an alpha olefin as comonomer, selected from propylene, buetene-1, hexene-1 and octene-1, a linear low density polyethylenes having a density lower than 0.940 g/cm³ is obtained with a very good quality is obtained which is indicated by the low ratio among weight of xilene soluble fraction and weight of comonomer in the chain. In addition, the catalysts of the invention also show the capability of producing polymers with a high bulk density.

In addition to the ethylene homo and copolymers mentioned above the catalysts of the present invention are also suitable for preparing very-low-density and ultra-low-density polyethylenes (VLDPE and ULDPE, having a density lower than 0.920 g/cm³, to 0.880 g/cm³) consisting of copolymers of ethylene with one or more alpha-olefins having from 3 to 12 carbon atoms, having a mole content of units derived from ethylene of higher than 80%; elastomeric copolymers of ethylene and propylene and elastomeric terpolymers of ethylene and propylene with smaller proportions of a diene having a content by weight of units derived from ethylene of between about 30 and 70%.

The following examples are given in order to further describe the present invention in a non-limiting manner.

### Characterization

The properties are determined according to the following methods:

### Melt Index:

Melt index (M.I.) are measured at 190° C. following ASTM D-1238 over a load of:
2.16 Kg, MI E=MI_{2.16}.
21.6 Kg, MI F=MI_{21.6}.
   The ratio: F/E=MI F/MI E=MI_{21.6}/MI2.16 is then defined as melt flow ratio (MFR)

Fraction soluble in xylene. The solubility in xylene at 25° C. was determined according to the following method: About 2.5 g of polymer and 250 mL of o-xylene were placed in a round-bottomed flask provided with cooler and a reflux condenser and kept under nitrogen. The mixture obtained was heated to 135° C. and was kept under stirring for about 60 minutes. The final solution was allowed to cool to 25° C. under continuous stirring, and was then filtered. The filtrate was then evaporated in a nitrogen flow at 140° C. to reach a constant weight. The content of said xylene-soluble fraction is expressed as a percentage of the original 2.5 grams.

### Comonomer Content

1-Butene was determined via Infrared Spectrometry.

The α-olefins higher than 1-butene were determined via Infra-Red analysis.

Effective density: ASTM-D 1505

Thermal analysis: Calorimetric measurements were performed by using a differential scanning calorimeter DSC Perkin-Elmer. The instrument is calibrated with indium and tin standards. The weighted sample (5-10 mg), obtained from the Melt Index determination, was sealed into aluminum pans, thermostatted at 5° C. for 3 minutes, heated to 200° C. at 20° C./min and kept at that temperature for a time long enough (5 minutes) to allow a complete melting of all the crystallites. Successively, after cooling at 20° C./min to −20° C., the peak temperature was assumed as crystallisation temperature (Tc). After standing 5 minutes at 0° C., the sample was heated to 200° C. at a rate of 20° C./min. In this second heating run, the peak temperature was assumed as melting temperature (Tm) and the area as the global melting hentalpy (ΔH).

### Determination of Ti⁺³)

0.5 g of the sample in powder form, are dissolved in 100 ml of HCl 2.7M in the presence of solid CO₂. The so obtained solution is then subject to a volumetric titration with a solution of FeNH₄(SO₄)₂. 12H₂O 0.1N, in the presence of solid CO₂, using as indicator of the equivalence point NH₄SCN (25% water solution). The stoichiometric calculations based on the volume of the titration agent consumed give the weight amount of Ti³⁺ in the sample.

### General Procedure for the HDPE Polymerization Test

Into a 4.5 liters stainless steel autoclave, degassed under N₂ stream at 70° C., 1.6 liters of anhydrous hexane, the reported amount of catalyst component and 0.5 g of triethylaluminum (TEAL) were introduced (or 0.87 g of TIBA). The whole was stirred, heated to 75° C. and thereafter 4 bar of H₂ and 7 bar of ethylene were fed. The polymerization lasted 2 hours during which ethylene was fed to keep the pressure constant. At the end, the reactor was depressurized and the polymer recovered was dried under vacuum at 60° C.

General Procedure for the LLDPE Polymerization Test

A 4.0 L stainless-steel autoclave equipped with a helical magnetic stirrer, temperature and pressure indicator, feed line for ethylene, propane, hydrogen, 1-butene and a steel vial for the injection of the catalyst was used and purified by flushing ethylene at 80° C. and washing with propane. In the following order, 1.2 g of TIBA (or 0.69 g of TEAL) and 12 mg of the solid catalyst matured for 5 minutes and introduced in the empty reactor in a stream of propane. The autoclave was then closed and 1.6 l of propane were introduced, after which the temperature was raised to 75° C. (10 minutes) with simultaneous introduction of ethylene up to 7 bar of partial pressure and 1-butene in the amount reported in table. At the end, 1.5 bar of hydrogen (partial pressure) were added. Under continuous stirring, the total pressure was maintained at 75° C. for 120 minutes by feeding ethylene (if the ethylene consumption reaches 200 g, the test is stopped before the two hours). At the end the reactor was depressurised and the temperature was dropped to 30° C. The recovered polymer was dried at 60° C. under a nitrogen flow and weighted.

Ethylene/1-butene Copolymerization in Gas-Phase

A 15.0 liter stainless-steel fluidized reactor equipped with gas-circulation system, cyclone separator, thermal exchanger, temperature and pressure indicator, feeding line for ethylene, propane, 1-butene, hydrogen, and with a 1 L steel reactor for the catalyst prepolymerization and/or injection of the catalytic system into the fluidized bed reactor. The gas-phase apparatus was purified by fluxing pure nitrogen at 40° C. for 12 hours and then was circulated a propane (10 bar, partial pressure) mixture containing 1.0 g of TEAL at 80° C. for 30 minutes. It was then depressurized and the reactor washed with pure propane, heated to 80° C. and finally loaded with propane (13.8 bar partial pressure), 1-butene (1.0 bar, partial pressure), ethylene (4.0 bar, partial pressure) and hydrogen (1.2 bar, partial pressure).

In a 100 mL three neck glass flask were introduced in the following order, 20 mL of anhydrous hexane, 0.6 g of TEAL (or 1.0 g of TIBA), 0.1 g of the catalyst (prepared according to the example 1). They were mixed together and stirred at room temperature for 5 minutes and then introduced in the 1 L reactor maintained in a propane flow.

By using overpressure, the activated catalyst was injected into the gas-phase reactor. The final pressure was about 20 bar, and it was kept constant during the polymerization at 80° C. for 120 minutes by feeding a 6 wt. % 1-butene/ethene mixture.

At the end, the reactor was depressurised and the temperature was dropped to 30° C. The collected polymer was dried at 70° C. under a nitrogen flow and weighted.

### EXAMPLE 1

### Preparation of the Spherical MgCl₂-EtOH Adduct

A magnesium chloride and alcohol adduct containing about 3 mols of alcohol and having average size of about 12 μm was prepared following the method described in example 2 of U.S. Pat. No. 4,399,054.

### Preparation of the Solid Component

The spherical support, prepared according to the general method underwent a thermal treatment, under N₂ stream, over a temperature range of 50-150° C. until spherical particles having a residual ethanol content of about 35% (1.1 mole of ethanol for each MgCl₂ mole) were obtained.

Into a 2 l glass reactor provided with stirrer, were introduced 1.0 l of TiCl₄, 70 g of the support prepared as described above and, at temperature of 0° C., 6 ml of 1,2-dimethoxyethane (Mg/DME=8 mol/mol). The whole mixture was heated and kept under stirring for 60 minutes at 100° C. After that, stirring was discontinued and the liquid siphoned off. Two washings with fresh hexane (1 liter) were performed at 60° C. and then, other two more hexane washings were performed at room temperature. The spherical solid component was discharged and dried under vacuum at about 50° C. The solid showed the following characteristics:

| Total titanium | 5.3% | (by weight) |
|---|---|---|
| Ti⁺³ | not present | |
| Mg | 17.4% | (by weight) |
| Cl | 63.2% | (by weight) |
| 1,2-dimethoxyethane | 3.7% | (by weight) |

The so prepared catalyst has then been used in the polymerization of ethylene according to the general polymerization procedure (first run with TEAL second run with TIBAL). The results are shown in Table 1.

Moreover, the catalyst was also used in the preparation of LLDPE according to the general procedure and the results shown in Table 2 have been obtained. In addition, the catalyst was also used in the gas-phase copolymerization of ethylene according to the procedure reported above (except that for run 3 and 4 catalyst component and cocatalyst were not pre-mixed but fed separately to the reactor). The results are shown in Table 3.

### EXAMPLE 2

A catalyst component was prepared according to the same procedure described in Example 1 with the only difference that 1,2-dimethoxyethane was used in such an amount to give a ratio Mg/DME=12 mol/mol.

The so prepared catalyst component had the following composition:

| Total titanium | 5.7% | (by weight) |
|---|---|---|
| Ti⁺³ | not present | |
| Mg | 17.7% | (by weight) |
| Cl | 62.3% | (by weight) |
| 1,2-dimethoxyethane | 2.8% | (by weight) |

The said catalyst has then been used in the polymerization of ethylene according to the general polymerization procedure (first run with TEAL second run with TIBAL). The results are shown in Table 1.

### EXAMPLE 3

A catalyst component was prepared according to the same procedure described in Example 1 with the only difference that 1,2-dimethoxyethane was used in such an amount to give a ratio Mg/DME=14 mol/mol.

The so prepared catalyst component had the following composition:

| Total titanium | 4.6% | (by weight) |
|---|---|---|
| Ti + 3 | not present | |
| Mg | 18.5% | (by weight) |
| Cl | 61.1% | (by weight) |
| 1,2-dimethoxyethane | 2.5% | (by weight) |

The said catalyst has then been used in the polymerization of ethylene according to the general polymerization procedure (first run with TEAL second run with TIBAL). The results are shown in Table 1.

### EXAMPLE 4

A catalyst component was prepared according to the same procedure described in Example 1 with the only difference that 1,2-dimethoxyethane was used in such an amount to give a ratio Mg/DME=16 mol/mol.

The so prepared catalyst component had the following composition:

| Total titanium | 4.5% | (by weight) |
|---|---|---|
| Ti + 3 | not present | |
| Mg | 17.6% | (by weight) |
| Cl | 62.0% | (by weight) |
| 1,2-dimethoxyethane | 2.2% | (by weight) |

The said catalyst has then been used in the polymerization of ethylene according to the general polymerization procedure (first run with TEAL second run with TIBAL). The results are shown in Table 1.

### EXAMPLE 5

A catalyst component was prepared according to the same procedure described in Example 1 with the only difference that 1,2-dimethoxyethane was used in such an amount to give a ratio Mg/DME=32 mol/mol.

The so prepared catalyst component had the following composition:

| Total titanium | 4.9% | (by weight) |
|---|---|---|
| Ti + 3 | not present | |
| Mg | 17.7% | (by weight) |
| Cl | 61.0% | (by weight) |
| 1,2-dimethoxyethane | 1.6% | (by weight) |

The said catalyst has then been used in the polymerization of ethylene according to the general polymerization procedure (first run with TEAL second run with TIBAL). The results are shown in Table 1.

### COMPARISON EXAMPLE 1

A catalyst component was prepared according to the same procedure described in Example 1 with the only difference that 1,2-dimethoxyethane was not used.

The said catalyst has then been used in the polymerization of ethylene according to the general polymerization procedure (first run with TEAL second run with TIBAL). The results are shown in Table 1.

### COMPARISON EXAMPLE 2

A catalyst component was prepared according to the same procedure described in Example 1 with the only difference that 1,2-dimethoxyethane was used in such an amount to give a ratio Mg/DME=5 mol/mol.

The so prepared catalyst component had the following composition:

| Total titanium | 5.6% | (by weight) |
|---|---|---|
| Ti + 3 | not present | |
| Mg | 17.3% | (by weight) |
| Cl | 61.8% | (by weight) |
| 1,2-dimethoxyethane | 5.5% | (by weight) |

The said catalyst has then been used in the polymerization of ethylene according to the general polymerization procedure (first run with TEAL second run with TIBAL). The results are shown in Table 1.

TABLE 1

| | Mileage | MIE | | B.D.P. | |
|---|---|---|---|---|---|
| EX. | (KgPE/gctz) | (g/10′) | F/E | g/cc | AlR₃ |
| 1 | 26.2 | 0.3 | 25.6 | 0.393 | TEAL |
| | 24 | 0.2 | 30 | 0.33 | TIBAL |
| 2 | 24.4 | 0.68 | 26.5 | 0.374 | TEAL |
| | 23.4 | 0.27 | 21.1 | 0.26 | TIBAL |
| 3 | 27.6 | 0.5 | 25.8 | 0.381 | TEAL |
| | 31.7 | 0.21 | 27.6 | 0.306 | TIBAL |
| 4 | 35.5 | 0.5 | 31 | 0.393 | TEAL |
| | 39.2 | 0.36 | 31.3 | 0.313 | TIBAL |
| 5 | 40.3 | 0.6 | 32.0 | 0.386 | TEAL |
| | 60.3 | 0.5 | 30.2 | 0.375 | TIBAL |
| Comp 1 | 40.3 | 1.2 | 36.1 | 0.354 | TEAL |
| | 25.9 | 0.24 | 44.2 | 0.229 | TIBAL |
| Comp. 2 | 14.4 | 0.51 | 26.5 | 0.302 | TEAL |
| | 9.6 | <0.1 | nd | 0.263 | TIBAL |

TABLE 2

| | C4-⁻ | | | | | C4- | | Xyl. |
|---|---|---|---|---|---|---|---|---|
| | feed | AlR₃ | Mileage | MIE | | bonded | Density | Sol. |
| | g | type | Kg/gcat | g/10′ | F/E | Wt % | g/cc | Wt % |
| Run1 | 180 | Tibal | 23 | 0.24 | 26.2 | 8.9 | 0.9196 | 7.9 |
| Run2 | 140 | Teal | 20 | 0.67 | 29.2 | 10.8 | 0.9173 | 16.5 |

TABLE 3

| | | | Bulk | | | | | | |
|---|---|---|---|---|---|---|---|---|---|
| | AlR₃ | Mileage | Density | MIE | | Tm | | Density | Xyl. Sol. |
| | type | Kg/gcat | g/cc | g/10′ | F/E | ° C. | C4- Wt % | g/cc | Wt % |
| Run1 | Teal | 7.3 | 0.31 | 0.33 | 27.6 | 125.3 | 6.4 | 0.9229 | 5.2 |
| Run2 | Tibal | 8.8 | 0.29 | 0.35 | 28.3 | 124.9 | 5.9 | 0.9236 | 3.8 |
| Run3 | Teal | 10 | 0.329 | 0.4 | 21.3 | 125.6 | 6.1 | 0.9226 | 4.7 |
| Run4 | Tibal | 7.3 | 0.325 | 0.4 | 26.3 | 125.6 | 6.2 | 0.9238 | 5 |

1. Catalyst components for the polymerization of olefins comprising Mg, Ti, halogen as essential elements and containing 1,2-dimethoxyethane in an amount of less than 4% wt with respect to the total weight of the catalyst component.

2. The catalyst components according to claim 1 wherein 1,2-dimethoxyethane is present in an amount ranging from 1 to 3.8% by weight.

3. The catalyst components according to claim 2 wherein 1,2-dimethoxyethane is present in an amount ranging from 1.4 to 3.5% by weight.

4. The catalyst components according to claim 1 wherein the Ti atoms derive from a titanium compound which contains at least one Ti-halogen bond, and the Mg atoms derive from magnesium chloride.

5. The catalyst components according to claim 4 wherein both the titanium compound and the 1,2-dimethoxyethane are supported on magnesium dichloride.

6. The catalyst components according to claim 4 in wherein the titanium compounds are selected from the halides or the compounds of formula TiXₙ(OR¹)₄₋ₙ, where 1≦n≦3, X is halogen, and R¹ is C₁-C₁₀ hydrocarbon group.

7. A catalyst for the polymerization of olefins CH₂═CHR, wherein R is hydrogen or a hydrocarbyl radical with 1-12 carbon atoms, comprising a product of the reaction between:
(a) a solid catalyst component comprising Mg, Ti, halogen as essential elements and containing 1,2-dimethoxyethane in an amount of less than 4% wt with respect to the total weight of the-catalyst component;
(b) an alkylaluminum compound; and optionally
(c) an external electron donor compound.

8. A process for the preparation of ethylene (co)polymers comprising polymerizing ethylene optionally in mixture with olefins CH₂═CHR, wherein R is an alkyl, cycloalkyl or aryl radical having 1-12 carbon atoms, in the presence of a catalyst comprising a product of the reaction between:
(a) a solid catalyst component comprising Mg, Ti, halogen as essential elements and containing 1,2-dimethoxyethane in an amount of less than 4% wt with respect to the total weight of the-catalyst component;
(b) an alkylaluminum compound; and optionally
(c) an external electron donor compound.

9. The catalyst components of claim 6 wherein the halogen is chlorine.
